(19) United States
(12) Patent Application Publication
(10) Pub. No.: US 2010/0121765 A1
(43) Pub. Date: May 13, 2010

(54) ELECTRONIC ONLINE VOTING SYSTEM

(75) Inventors: Andreas Ahrens, Herzogenrath (DE); Johannes Buchmann, Darmstadt (DE); Frank Heinold, Roetgen (DE); Engelbert Mues, Bp Vaals (NL); Anton Vossel, Alsdorf (DE)

Correspondence Address: DARBY & DARBY P.C., P.O. BOX 770, Church Street Station, New York, NY, 10008-0770, US

(73) Assignee: Deutsche Telekom AG, Bonn (DE)

(21) Appl. No.: 12/438,644

(22) PCT Filed: Aug. 17, 2007
(86) PCT No.: PCT/DE07/01458

§ 371 Date: Nov. 20, 2009

(30) Foreign Application Priority Data
Aug. 24, 2006 (DE) 10 2006 039 662.6

(51) Int. Cl. G06Q 99/00; H04L 9/00; H04L 9/32

(52) U.S. Cl. 705/50

(57) ABSTRACT

A digital voting method for a computer system having a voting booth system, a validator system, and a bulletin board system, where the validator system has access to certificates of authorized voters, includes generating using the voting booth system, a vote; blinding/signing the vote using a signature of the voter; sending the blinded/signed vote to the validator; verifying the voter's signature; checking that the voter is authorized, and checking whether the voter has received a validator signature, wherein if not the validator signs the blinded vote; sending the validator signature back to the voting booth system; unblinding the signature; verifying the validator signature, and if correct encrypting the vote along with the validator signature using a tallier's public key; encrypting the vote using a public key to provide a dual-encrypted vote displayable to the voter; transferring the dual-encrypted vote to the bulletin board; and if the voter is authorized publishing the dual-encrypted vote.

### CLAIM OF PRIORITY

This application is a U.S. national phase application under 35 U.S.C. §371 of International Patent Application No. PCT/DE2007/001458 filed Aug. 17, 2007, which claims the benefit of priority to German Patent Application No. 10 2006 039 662.6, filed Aug. 24, 2006. The International Application was published in German on Feb. 28, 2008 as WO/2008/022624. The disclosures of all of which are hereby incorporated by reference in their entireties

### FIELD

The present invention relates to devices and methods for secure electronic voting on the Internet, intranet or another computer network, and particularly to a secure protocol method for electronic voting.

### BACKGROUND

David Chaum, Blind Signature System, In Advances in Cryptology: Proceedings of Crypto '83, pages 153-156. Plenum Publishing, 1983, describes blind signatures, and David Chaum, Untraceable Electronic Mail, Return Addresses and Digital Pseudonyms. Communications of the ACM, 24 (2): 84-88, 1981, describes mix networks. A public channel that displays the voting information for everyone is also required.

To achieve secrecy and authentication, public key systems are used, such as RSA. Ronald L. Rivest, Adi Shamir, and Leonard M. Adleman, A Method for Obtaining Digital Signatures and Public Key Cryptosystems, Communications of the ACM, 21 (2): 120-126, 1978, describes a public key system such as RSA.

Communication is protected by a protocol such as PKI-based transport layer protocol (“TLS”). Tim Dierks and Christopher Allen, The TLS Protocol. IETF RFC 2246, January 1981, describes a transport layer protocol system.

The correct operation of a mix network system is verifiable by a zero knowledge method. Goldwasser, Shafi; Micali, Silvio; Rackoff, Charles: The Knowledge Complexity of Interactive Proof Systems, In: STOC '85: Proceedings of the Seventeenth Annual ACM Symposium on Theory of Computing. New York, N.Y., USA: ACM Press, 1985, pp. 291-304, describes a zero knowledge method.

An electronic voting protocol must meet a variety of security requirements that depend on the application context in which the protocol is used.

Although the security requirements for electronic voting schemes are not standardized, scholars do, however, agree on a given set of requirements.

Accuracy:
A valid vote cannot be changed.
All valid votes are counted.
Invalid votes are not counted.

Democracy:
Only authorized voters can vote.
Each voter casts only one vote.

Confidentiality:
Anonymity: It is not possible to associate a vote with the voter who cast it.
Untraceability: No voter can prove that he cast a specific vote.
Freedom from coercion: A voter cannot be forced to cast a specific vote.
All votes remain secret until the end of the election.

Verifiability:
Universal: Anyone can verify that all valid votes were counted.
Individual: All voters can verify that their own valid votes were counted.

This results in a series of technical problems that must be solved for execution on a computer system.

### SUMMARY

In one embodiment, the present invention provides a digital voting method, for a computer system which includes a voting booth system, a validator system, and a bulletin board system, wherein the validator system has access to certificates of a plurality of authorized voters on the bulletin board system. The method includes the steps of generating, by at least one voter using the voting booth system, a vote; blinding and signing the vote using a signature of the at least one voter; sending the blinded and signed vote to the validator system; verifying, by the validator system, the signature of the at least one voter, and checking, by the validator system, whether the at least one voter is among the plurality of authorized voters and whether the at least one voter has already received a validator signature from the validator, and if the verifying and the checking are successful signing, by the validator, the blinded vote; sending the validator signature back to the voting booth system; obtaining, by the voting booth system, the validator signature on the vote by unblinding the signature; verifying the validator signature, and if the validator signature is correct, encrypting the vote along with the validator signature, using a tallier's public key; encrypting, by the voting booth system, the encrypted vote using a public key of a mix network so as to provide a dual-encrypted vote, wherein the dual-encrypted vote is displayable to the at least one voter; transferring the dual-encrypted vote to the bulletin board system; and if the voter is among the plurality of authorized voters, publishing, by the bulletin board system, the dual-encrypted vote.

### BRIEF DESCRIPTION OF THE DRAWINGS

The figures to which the following detailed description of the preferred embodiment refers are described below.

FIG. 1 illustrates a method embodying one aspect in accordance with the present invention;

FIG. 2 illustrates a method embodying another aspect in accordance with the present invention; and

FIG. 3 illustrates the role model of individual entities in accordance with the invention.

### DETAILED DESCRIPTION

The invention specifies a protocol analysis. This analysis is based on the security requirements for electronic voting schemes that are widely accepted by the scientific community. The protocol uses blind signatures and mix networks.

By way of overview and introduction, embodiments of the invention provide a computer-supported method and a computer-supported device which implement secure electronic voting.

Embodiments of the invention use an authentic public bulletin board system where anyone may read the messages published there, while only authorized parties may post messages. In addition, no one is able to delete or overwrite messages once they have been written.

Blind signatures are used to prevent the signatory from being able to reach a message to be signed. As a further anonymization technique a mix network can also be employed. In principle, a mix network receives a quantity of messages, encrypts them and forwards the new messages in randomized order. The network thereby breaks the link between incoming and outgoing messages.

The following parties are participants in a method embodying the invention:

| | |
|---|---|
| Voter (WAH) | The voter casts votes in an area that is not |
| | viewable by third parties. |
| Validator (BES) | The validator is responsible for validating |
| | the votes. |
| Bulletin board (SWB) | The bulletin board is an authentic public |
| | message area. |
| Mix network (MIX) | The mix network mixes the votes cast. |
| Tallier (AUS) | The tallier is responsible for tallying the |
| | votes. |

The following notation is used in the protocol description:

| | |
|---|---|
| EL(m) | Encryption of message m using the public key of L. |
| ST(m) | Signature on message m using the private key of T |
| B(m, r) | Function for blinding message m, using a random number r. |
| UB(m, r) | Function for unblinding message m, which was blinded with r. |
| v | A completed ballot, also referred to as a vote. |

In the preferred embodiment, the following configuration is provided:

A trustworthy public key infrastructure (PKI) is available and it is used. All public keys used are validated.

A certification center issues corresponding PKI certificates. This implies that all encryptions use the correct public keys. All parties participate in the PKI. The cryptography used is robust and is practically impossible to break.

A protocol such as TCP/IP, which ensures the receipt of the messages, is used for communication. It is also assumed that communication is protected by a protocol such as PKI-based transport layer protocol (“TLS”), which guarantees the reciprocal authentication of the parties and the confidentiality of the communication.

The registration phase proceeds in a correct manner. This is ensured by the current manual identification and registration of the authorized voter. For this purpose, the certificates of all voters are published on the bulletin board prior to the vote-casting phase.

There is a trustworthy access control for accessing the electronic voting booth. This ensures that only authorized voters enter the booth, and only one person occupies the booth at a give time. The booth is mechanically constructed in such a way that it is not possible to monitor the voting process. This includes side-channel attacks (e.g., by analyzing power consumption).

The electronic voting booth system is trusted as follows:
A voting client software program that neither changes nor replaces the vote generated by the voter runs on the electronic voting booth system. This program creates the exact vote that the particular voter wishes to cast. (Software verification in combination with the hardware.)
The booth guides the voter through the voting process (e.g., via electronic menu structures). The voter is not able to generate a technically invalid vote—however, it is possible to generate a legally invalid vote. The inability to generate a technically invalid vote includes verification of the validator's signature on the vote. The mechanical construction of the voting booth prevents the voter from manually intervening into the operation of the voting client software program.
The voter is able to actively abstain from voting, e.g., by way of a corresponding option on the electronic ballot or by checking more that the allowed number of votes (it is also conceivable that abstention from voting is excluded by the electoral regulations, in which case this aspect does not apply; as a rule, however, abstention is allowed)—Generation of a legally invalid vote.
Neither the voter nor any other third party is able to view or store the factor used by the voting booth to blind the vote. Viewing or storing the factor is prevented, on the one hand, by the mechanical construction of the voting booth, which does not allow data to be removed or exported. Furthermore, the vote-blinding factor is not visibly stored in the main memory of the voting booth system, this memory being securely erased after the voting process ends and/or is cancelled.
The voting booth displays to the voter the vote that was published for him on the bulletin board. The voter must explicitly validate the vote before it is stored on the bulletin board.
The voting booth does not collude with other parties. The voting client software program follows only the steps of the voting protocol and therefore communicates only with the parties known to the system.

The system or the method implementing the bulletin board is trusted as follows:
It correctly authenticates the subscribers and authorized their access according to the subscribers' roles. The roles are securely authenticated by the PKI on which the system is based.
An access and authorization concept underlying each election governs the ability to read and write data from or to the bulletin board. This makes it impossible to prevent authorized persons from publishing information.
The bulletin board is unable to change or delete information. This restrictive data concept of the bulletin board doe not provide for data modification or deletion. Once data has been written, it may not be deleted or changed. This approach is supported by modern database technologies or the use of special data media (e.g., WORM (write once, read multiple) technology).
The bulletin board does not collude with other parties. The corresponding software programs follow the exact provisions of the voting protocol, which does not allow impermissible activities or communication.

The mix network is also trustworthy in the following sense:
It mixes correctly. The votes are randomized by mixing the total number of votes. For this purpose, all votes are first read from the bulletin board by the mix network system in the known order. The votes are mixed on the basis of a random result, which enables the mixed votes to be stored on the bulletin board in modified order, independently of the order in which they were received.
To prevent any role other than the mix network system from mixing the votes, all votes are encrypted during the voting process itself by the voting client software program, using the public key of the mix network system. Using the associated private key, the system is able to decrypt and subsequently mix the votes. The mix network therefore does not reveal the private key or the permutation used.
Furthermore, the mix network system is unable to add votes or to replace or change them. The correct operation of the mix network system is verifiable by a zero knowledge method.
The mix network does not collude with other parties. The corresponding software programs follow the exact provisions of the voting protocol, which does not allow impermissible activities or communication.

As a result, the trustworthy parties are as follows:
The voting booth system/method.
The bulletin board system/method.
The mix network system/method.

The following parties may be regarded as untrustworthy:
The voters.
The validator system/method.
The tallier system/method.

The voting method embodying the present invention nevertheless guarantees a correct election, even if the aforementioned parties do not act in proper accordance with their assigned roles. Misconduct would result in irregularities and be detected.

According to the preferred embodiment, therefore, a valid vote is one that:
has the correct format;
has been electronically signed by the validator system/method;
is encrypted by the public key of the tallier and the mix network in the correct order;
is published on the bulletin board.

The method essentially comprises three phases: the registration phase, the voting phase and the tallying phase.

The registration phase is outside the scope of the protocol according to the invention. The only requirement is that a list of authorized voters and their certificates be published on the bulletin board at the end of this phase. Anyone is able to verify this list.

In a first step, the validator system retrieves the list of certificates of the authorized voters from the bulletin board. This is advantageously done once at the beginning of the voting phase, but can be repeated on an individual basis whenever the voter's certificate needs to be checked.

The following steps are repeated for each voter:

The voter generates his vote with the aid of the voting booth system.

The vote is blinded and signed by the voter's signature. It is then sent to the validator system. The validator system verifies the signature, checks the voting authorization and signs the blinded vote. A check is also made to see whether this voter has already received a signature. If all these conditions apply, the validator system signs the blinded vote and sends the signature back to the voter.

The voting booth system then obtains the validator's signature for the vote by unblinding the signature. The validator's signature is verified.

If this is correct, the vote is encrypted, along with the validator's signature, using the tallier's public key. The voting booth then encrypts the result, using the public key of the mix network. The result is displayed to the voter.

If the voter is authorized and has not yet cast a vote, the bulletin board system allows the vote to be published.

After the voting phase, the mix network retrieves the dual-encrypted votes from the bulletin board.

The mix network removes the outer encryption of the votes, using its private key. It then mixes the votes and sends the new list back to the bulletin board. At this point in time, the votes are still encrypted by the tallier's key.

The tallier system then retrieves the new list from the bulletin board system and decrypts the votes. It verifies the validator's signature on the votes and checks whether the votes are valid. It then calculates the election result.

Finally, the tallier publishes all valid and invalid votes, including their signatures, at the corresponding locations on the bulletin board. The tallier also publishes his private key and the election result on the bulletin board.

Protocol Analysis

All valid votes are published on the bulletin board. Each vote is dual-encrypted, first using the tallier's key and then using the mix network key.

If someone other than the mix network and the tallier wishes to change a vote, he must break the cryptographic system used, which is not possible.

An unscrupulous tallier could show his private key to an attacker who is attempting to change the votes. Since the bulletin board does not permit changes, and the mix network does not disclose its private key, this attacker is unable to be successful.

After mixing the votes, the mix network re-publishes them on the bulletin board. These votes are still encrypted by the tallier's key. An attacker who knows the tallier's private key would be able to attempt to falsify the votes. Since the bulletin board does not allow changes, it will not allow such falsification.

In addition, anyone may see whether votes were changed by tracking the process on the bulletin board.

The voter uses the trustworthy voting booth to create and verify his votes. This ensures that the vote is created correctly.

The trustworthy nix network receives the dual-encrypted votes from the trustworthy bulletin board, mixes them and re-publishes them on the bulletin board. The votes are now encrypted only by the tallier's key. An unscrupulous tallier would be able to read the votes from the bulletin board, decrypt them and publish a false result.

However, since the tallier must publish his private key during the tallying phase, anyone can check whether all votes were handled correctly. This is achieved by decrypting the votes (from the bulletin board) and verifying the validator's signatures.

The fraudulent mix network would be able to delete votes. Although this would be easy to detect, there would be no way to restore the deleted votes.

Since the mix network is trustworthy, it does not subvert the protocol.

The voting booth ensures that only valid votes are published. Even if an invalid vote (incorrect structure, invalid signature, faulty encryption) were to be published, this would be detected when the tallier decrypts the votes.

An unscrupulous tallier would be able to invalidate votes. Anyone would be able to detect this, since the tallier must publish his private key. As a result, anyone is able to decrypt the votes (from the bulletin board) and check the validator's signature.

Democracy

In addition, only authorized voters are able to vote; as long as the validator is scrupulous, he correctly recognizes authorized voters on the basis of their digital certificates.

If the validator is unscrupulous, he would not be able to authorize votes of persons not authorized to vote. Since the bulletin board accepts only votes from authorized voters, it will reject the falsified votes.

Each voter casts only one vote; as long as the validator is scrupulous, he will reject multiple attempts to vote. An unscrupulous validator would be able to validate more than one vote for a single voter. However, since the trustworthy bulletin board recognizes the voter, it prevents multiple voting attempts.

Confidentiality

In addition, confidentiality is ensured. It is not possible to associate a vote with the voter who cast it. It is also not possible to associate a vote with a voter by monitoring the network traffic, since the votes are encrypted and mixed.

Moreover, it is not possible to link a vote with the voter by comparing the time the vote was cast and the time at which a vote appears on the bulletin board, since the votes are mixed prior to decryption.

Even if the validator, the bulletin board and the tallier collaborate, they are unable to establish a relationship between the vote and the voter.

The tallier has no knowledge of the content of a vote that he signs, the bulletin board receives only the encrypted votes from the voter, and the tallier receives a mixed list. Furthermore, the bulletin board and the mix network are trustworthy and would not cooperate.

The voters ask the validator to validate their votes. Since this is done using blind signatures, even an unscrupulous validator has no way of identifying the votes.

The voters publish their votes on the bulletin board, and anyone is able to view the encrypted votes. The mix network's private key is required to decrypt the votes before they are mixed. Since the mix network does not cooperate, this is not possible. If the votes are decrypted after mixing, using the tallier's private key, the link with the voter has disappeared, since the votes have been mixed.

No voter is able to prove that he cast a particular vote. A voter would be able to have the honest validator validate his vote and show this validation in order to prove his vote. However, since the voter is forced to vote using a voting booth system that withholds the critical information, the voter is unable to present the critical information.

A voter would be able to cooperate with a dishonest validator to prove his vote. The voter would be able to easily show the validator his blinding factor. Once again, it is not possible for the voter to do this, since he lacks the necessary information.

A voter may not be forced to cast a particular vote. Since the mix network and the voting booth system are trustworthy, the voter has no way to display or prove his vote. The voting booth also ensures that the voter may not be monitored while he is voting.

A voter may abstain from voting while in the voting booth. If he does this, it is not possible to determine whether he has voted at all.

All votes remain secret until the end of the election. The votes are dual-encrypted by the keys of the mix network and the tallier. The only way to decrypt the votes prior to the end of the election is to use the private keys of these instances.

Even if an attacker accesses the tallier's private key, he is not able to decrypt the votes. He also requires the private key of the mix network. Since the mix network is trustworthy, it will not cooperate with the attacker. Therefore, the votes remain secret until the end of the election.

Verifiability

Anyone can verify that all valid votes were counted.

After the registration phase, a list of all authorized voters is published on the bulletin board. This list enables anyone to check who is authorized to vote. The associated certificates may also be verified. Since the voters and their votes as well as the mix network publish the mixed list on the bulletin board, anyone is able to compare the number of original and mixed votes. Furthermore, a zero-knowledge method makes it possible to prove that the mix network is operating properly. Since the bulletin board and the mix network are trustworthy, they do not exchange, add or delete votes. Once the tallier has decrypted the votes, the tallier verifies the validator's signatures and publishes the result. The tallier also publishes his private key on the bulletin board. This enables any person to decrypt the votes and check their signatures. As a result, anyone can check whether all votes were counted and whether the validator worked properly. Each voter may verify that his valid vote was counted. Since the voter publishes his encrypted vote on the bulletin board, he can check whether the published vote is the same vote he created via the voting booth. As shown above, it is possible to verify that all valid votes were counted. The direct consequence is that each individual valid vote was counted.

A number of components incorporated in embodiments of the invention are described in detail below.

The bulletin board/system is a passive data memory. This means that the bulletin board is not able to accept or set up communication of its own. In this connection, the bulletin board/system is, in fact, also viewed as an instance, since it is not an actor like the other parties.

Taking into account the rights of actors, data may be either read from or written to the bulletin board. In keeping with the restrictive approach of this invention, it is therefore not possible to subsequently change the data once it has been written.

The bulletin board is implemented in the form of a software database that supports the corresponding access rules for implementing this invention. The restrictive data access protection mechanism is achieved and secured by implementing the access rights in the software server programs of the individual roles corresponding to the software client programs.

Access authorizations for the bulletin board are defined via security policies in order to rule out data manipulation. As a result, it is not possible to change the data on the bulletin board by read access. To maintain information confidentiality, however, no global read authorization exists for all roles, but instead access to the data on the bulletin board is restricted in time and depending on the role. In addition to read authorization, a time and role-dependent access restriction also exists for write access. Once data has been written, as a rule it may no longer be changed—with the exception of the voting status of the election. For example, the loss of votes by deleting them from the bulletin board is therefore ruled out. Only the voting status of the election may be changed by write access at the end of a specific phase in a predefined order and only by the role of the election board.

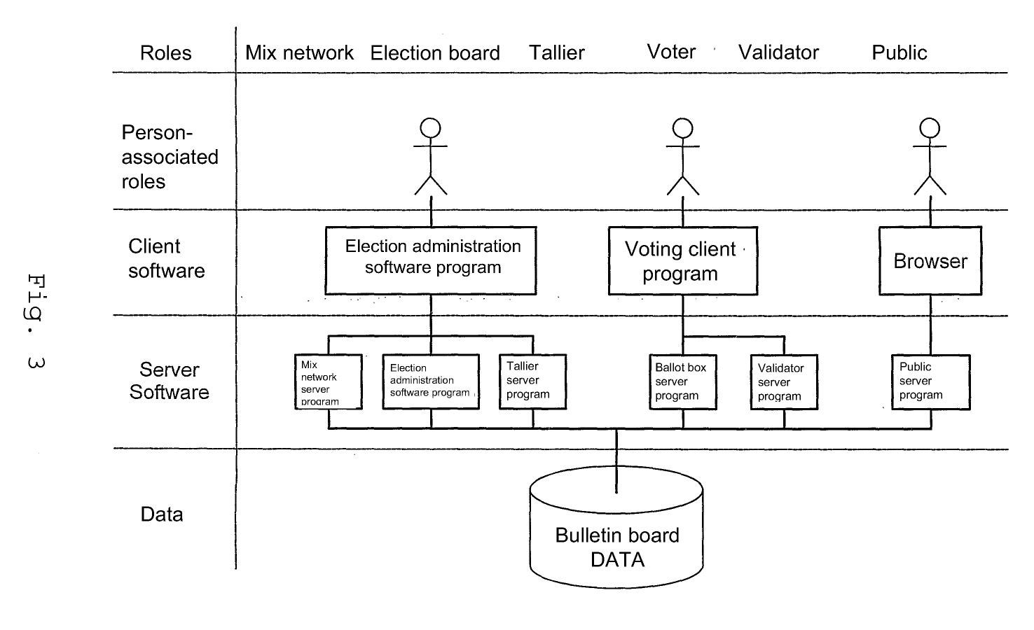

The individual roles are described in detail below with regard to the different election phases. FIG. 3 illustrates the role model of these individual entities in accordance with an embodiment of the invention.

The voter creates the vote with the assistance of the voting cabinet system (voting client program) and stores it on the bulletin board. The vote is provided with a blind signature by the validator as proof of voting authorization.

The voting client program displays the electronic ballot to the voter, allows the voter to fill out the ballot and creates the vote therefrom. The voter is able to render his vote invalid in the legal sense by intentionally checking more options than the number allowed by this voting method. In the vote selection validation dialog, the system clearly notifies the voter that the vote was stored as an invalid vote by the electronic voting system and will be counted as such during analysis. The purpose of this, in particular, is to prevent the voter from unintentionally checking more options than the number allowed, or to notify the voter of this circumstance. After establishing the voter's choice of vote, the voting client program communicates with the validator server program to have the vote, which was previously blinded by the voting client program (blind signature) validated by requesting validation of the vote. If the voting authorization is valid, the validator server program validates the vote, rendering the voter's vote valid.

The voting client program then encrypts the vote, along with the validator's signature, using the tallier's public key and subsequently using the public key of the mix network. Finally, the voting client program communicates with the ballot box server program to store the encrypted vote on the bulletin board. The ballot box server program first checks the voter's voting authorization on the basis of the voter certificate stored on the bulletin board as well as the voter status. Once the vote has been successfully stored, the ballot box server program updates the voter status on the bulletin board.

The time-dependent authorization of the ballot box server program to access the data on the bulletin board is embodied accordingly.

The validator received a vote from the voter (voting client program) that is rendered unidentifiable by blinding and is also signed by the voter. The validator first checks the voter's voting authorization against the voter certificate stored in the bulletin board as well as the voter's voting status. If the check is successful, the validator sends the blinded vote, along with his signature (validator's signature), back to the authorized voter for validation.

The time-dependent authorization of the validator server program to access the data on the bulletin board is embodied accordingly.

The mix network is responsible for reorganizing the stored (encrypted) votes prior to tallying so that a correlation between the authorized voter and the vote may not be established.

The mix network is designed as a mix network server program and communicates with the election administration software program. Once the election administration software program has initiated the mix network server program, the latter runs independently until the mixing of all votes has been completed. Only the role of the election board is able to initiate this process via the technical resource (election administration software program).

For this purpose, the mix network server program reads the unmixed votes from the bulletin board and removes the outer encryption, using the private key of the mix network. The encrypted votes are first collected in the local cache of the mix network. After all votes are located in the cache, they are mixed by a random number algorithm and stored in random order on the bulletin board. The local cache of the mix network is then fully erased.

The particular status of the mix network server program may be queried by the election administration software program.

The time-dependent authorization of the mix network server program to access the data on the bulletin board is embodied accordingly.

The tallier encrypts and checks the mixed votes and ascertains the election result therefrom.

The tallier is technically implemented as a tallier server program and communicates with the election administration software program. The election administration software program first initiates the tallying process by requesting a list of all mixed votes from the bulletin board. After all mixed votes have been transferred to the election administration software program, the votes are decrypted and tallied. To tally the votes, the corresponding signature of the validator is used to check the validity of the vote. The result is calculated from the summation of all votes.

Finally, the list of all valid and invalid votes, the associated validator's signatures, the tallier's private key as well as the election result are published on the bulletin board. For this purpose, this data is transferred to the tallier server program via the election administration software program and thereby published on the bulletin board.

The time-dependent authorization of the tallier server program to access the data on the bulletin board is specified accordingly.

Consequently, the security requirements for electronic voting systems are taken into account. Furthermore, the requirements of accuracy, democracy, confidentiality and verifiability, which are fundamental to the security of an election, were taken into account.

An existing trustworthy PKI was used for fulfillment. Communication is guaranteed and secured by protocols such as TCP/IP and TLS. The protocol uses blind signatures and a mix network. The voters are unable to obtain receipts, since this is prevented by the voting booth. The voting booth, bulletin board and mix network were assumed to be trustworthy. Conversely, the voter, validator and tallier do not have to be trusted. It was also demonstrated that untrustworthy parties are forced to behave in an honest manner.

If they subvert the protocol, this action is detected.

The protocol requires a small number of messages. The validator retrieves the list of certificates only once. Each voter requires only three messages to cast his vote. During the tallying phase, the overall communication volume is equal to the volume in the complete voting phase.

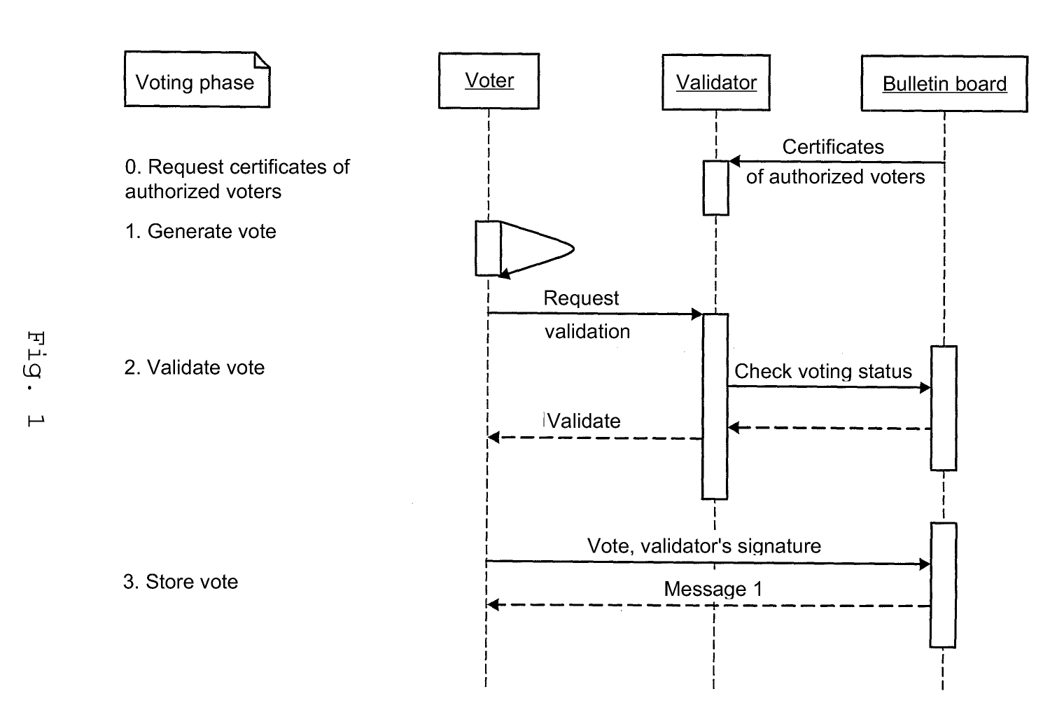

FIG. 1 illustrates the method steps during the voting phase.

Step 0: The validator retrieves the list of certificates of authorized voters from the bulletin board. This is done once at the beginning of the voting phase.

The following steps 1-3 are repeated for each voter.

Step 1: The voter generates his vote v with the aid of the voting booth. The booth generates a random number r and uses it to blind the vote;

i.e., the booth calculate x=B(v, r). The voter then signs x, which is sent to the validator as (x, S_{WAH}(x)).

Step 2: The validator verifies the voter's signature, checks whether the voter is authorized to vote and checks whether this voter has already received a signature. If all of this applies, the validator signs x and sends the signature S_{BES}(x) back to the voter.

Step 3: After receiving S_{BES}(x), the voting booth removes blinding factor r and obtains validator's signature S_{BES}(v). The booth verifies this signature. If it is correct, vote v is encrypted, along with validator's signature S_{BES}(v), using the tallier's public key—i.e., the booth calculates E_{AUS}(v, S_{BES}(v)). The voting booth then encrypts the result, using the pubic key of the mix network, and obtains E_{MIX}(E_{AUS}(v, S_{BES}(v)). The result is displayed to the voter. If the voter is authorized and has not yet cast a vote, the bulletin board allows him to publish E_{MIX}(E_{AUS}(v, S_{BES}(v)).

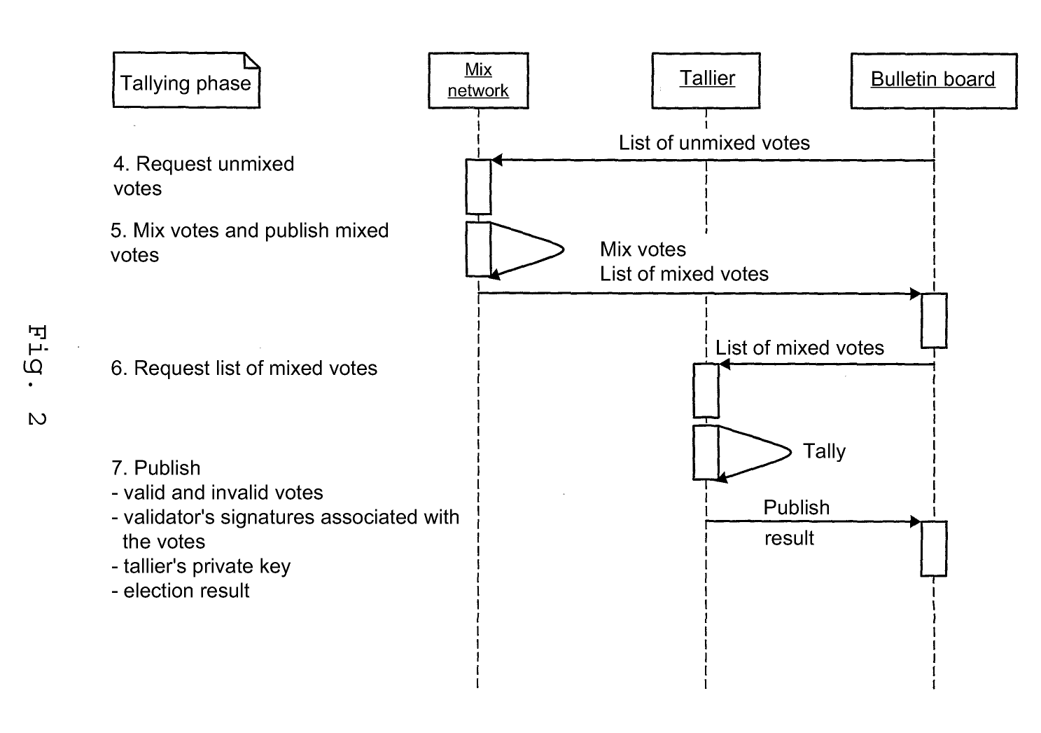

FIG. 2 illustrates the individual steps of the tallying phase.

Step 4: After the voting phase, the mix network retrieves the dual-encrypted votes from the bulletin board.

Step 5: The mix network removes the outer encryption of the votes, using its private key. It then mixes the votes and sends the new list back to the bulletin board. At this point in time, the votes are still encrypted by the tallier's key.

Step 6: The tallier then retrieves the new list from the bulletin board and decrypts the votes. He verifies the validator's signatures on the votes and checks whether the votes are valid. The tallier then calculates the election result.

Step 7: Finally, the tallier publishes all valid and invalid votes, including their signatures, at the corresponding locations on the bulletin board. The tallier also publishes his private key and the election result on the bulletin board.

1-41. (canceled)

42. A digital voting method, for a computer system which includes a voting booth system, a validator system, and a bulletin board system, wherein the validator system has access to certificates of a plurality of authorized voters on the bulletin board system, the method comprising the steps of:
generating, by at least one voter using the voting booth system, a vote;
blinding and signing the vote using a signature of the at least one voter;
sending the blinded and signed vote to the validator system;
verifying, by the validator system, the signature of the at least one voter, and checking, by the validator system, whether the at least one voter is among the plurality of authorized voters and whether the at least one voter has already received a validator signature from the validator, and if the verifying and checking are successful signing, by the validator, the blinded vote;
sending the validator signature back to the voting booth system;
obtaining, by the voting booth system, the validator signature on the vote by unblinding the signature;
verifying the validator signature, and if the validator signature is correct, encrypting the vote along with the validator signature, using a tallier's public key;
encrypting, by the voting booth system, the encrypted vote using a public key of a mix network so as to provide a dual-encrypted vote, wherein the dual-encrypted vote is displayable to the at least one voter;
transferring the dual-encrypted vote to the bulletin board system; and
if the voter is among the plurality of authorized voters, publishing, by the bulletin board system, the dual-encrypted vote.

43. The method according to claim 42, further comprising an initialization step wherein the validator system retrieves a list of certificates of the plurality of authorized voters from the bulletin board, so that the at least one voter's certificate can be subsequently checked.

44. The method according to claim 42, further including the following steps:
retrieving, by the mix network, after the voting phase a plurality of dual-encrypted votes from the bulletin board;
removing, by the mix network, the outer encryption of the dual-encrypted votes, using a private key of the mix network;
mixing, by the mix network, the votes and sending anew list back to the bulletin board, wherein the votes are still encrypted by the tallier's key;
retrieving, by the tallier system, the new list from the bulletin board system and further decrypting the votes;
verifying, by the tallier system, the validator signatures on the votes so as to check whether the votes are valid; and
if the votes are valid, calculating, by the tallier system, the election result.

45. The method according to claim 42, further comprising the step of publishing, by the tallier system, all valid and invalid votes, including their respective signatures, at corresponding locations on the bulletin board.

46. The method according to claim 45, wherein the tallier system further publishes its private key and the election result on the bulletin board.

47. The method according to claim 42, wherein the voting booth system asks the validator system to validate the vote, whereby because the validation is done using blind signatures, even an unscrupulous validator has no way to identify the votes.

48. The method according to claim 42, wherein the voting booth system provides a dialog which allows the voter to abstain from voting.

49. The method according to claim 42, wherein the bulletin board system includes a passive data memory that is unable to accept or set up a communication of its own so that the bulletin board is not an actor in the computer system, and wherein the bulletin board system provides all data required for carrying out the voting process, taking into account security policies, wherein the data can be either read or written, taking into account the rights of others of the plurality of subsystems, with out being possible to change the data subsequently.

50. The method according to claim 42, wherein the bulletin board system is a database containing data, wherein the bulletin board system supports corresponding access rules for implementing security policies having restrictive access protection of the data, which is achieved and secured by server programs of respective ones of the plurality of subsystems.

51. The method according to claim 42, wherein data can not be changed once it has been written to the bulletin board system, with the exception of an election voting status.

52. The method according to claim 42, wherein the voting booth system interactively fills out an electronic ballot and stores the vote produced thereby on the bulletin board system, wherein a blind signature is attached to the vote so that the validator system can verify whether the vote is authorized.

53. The method according to claim 42, wherein the voting booth system displays an electronic ballot to the at least one voter using a voting client program, receives a filled-out electronic ballot from the at least one voter, and creates the vote therefrom, wherein the voting client program requires the voter to identify himself to the voting booth system using a PKI identification data.

54. The method according to claim 42, wherein if a vote is incorrectly cast, the voting booth system notifies the at least one voter in a vote selection validation dialog that the vote is stored in the electronic voting system as an invalid vote in the legal sense and also tallied as such during analysis.

55. The method according to claim 53, further comprising the steps of:
after detecting the vote choice of the at least one voter, a voting booth client program communicates with a validator server program so as to validate the vote, which was previously blinded by the voting booth client program, by requesting validation of the vote;
if the voting authorization is valid, validating, by the validator server program, the vote thereby rendering the vote valid;
encrypting, by the voting booth client program the vote, using a tallier's public key and subsequently using a public key of the mix network;
communicating, by the voting booth client program, with a ballot box server program so as to store the encrypted vote on the bulletin board system;
first checking, by the ballot box server program, whether the at least one vote is among the plurality of authorized voters on the basis of the certificate on the bulletin board system and a status of the at least one voter; and
updating, by the ballot box server program, the status of the at least one vote when the vote is successfully stored.

56. The method according to claim 42, wherein
the validator system includes a validator server program that communicates with a voting booth client program;
the validator server program has read access to the bulletin board system;
the validator server system receives a blinded and signed vote from a voting booth client program and checks the signature, voting authorization and voting status of the at least one voter on the basis of the certificates of the plurality of authorized voters, and if this is successful, the blinded vote is signed and the validator signature is sent back to the voting booth client program.

57. The method according to claim 42, further including the steps of:
reading, by a mix network server program, unmixed votes from the bulletin board system and removing an outer encryption, using a private key of the mix network;
wherein the dual-encrypted votes are first collected in a local cache of the mix network;
after all the dual-encrypted votes are collected in the cache, mixing the dual-encrypted votes, by a random number algorithm, and storing the dual-encrypted votes in random order on the bulletin board system; and
erasing the local cache of the mix network.

58. The method according to claim 57, wherein a particular status of the mix network server program is queried by an election administration server program.

59. The method according to claim 58, wherein:
a tallier server program communicates with the election administration software program;
tallying is initiated by requesting a list of all mixed votes from the bulletin board, wherein during the tallying of the mixed votes, a corresponding signature of the validator system is used to check a respective mixed vote for validity; and
the election result is calculated from the summation of all votes;
wherein a list of all valid and invalid votes, the associated validator system's signature, the tallier's private key, and the election result are published on the bulletin board system.

60. A digital voting device, which includes a computer system having a plurality of subsystems including a voting booth system, a validator system, and a bulletin board system, wherein the validator system is configured to access certificates of authorized voters on the bulletin board system, the voting device comprising:
means in the voting booth system configured to enable a voter to generate a vote;
means configured to blind and sign the vote using a signature of the voter;
means configured to send the vote to the validator system;
means, in the validator system, configured to verify the signature of the voter, to check an authorization of the vote, and to check whether the voter has already received a signature of the validator system, and, if the verification and checking are successful, attach the signature of the validator system to the blinded vote;
means, in the validator system, configured to send the signature back to the voting booth system;
means, in the voting booth system, configured to obtain the signature of the validator system on the vote by unblinding the signature;
means configured to verify the signature of the validator system and, if valid, further configured to encrypt the vote along with the signature of the validator system, using a public key of a tallier system;
means, in the voting booth system, configured to then encrypt the encrypted vote using a public key of a mix network so as to provide a dual-encrypted result, wherein the dual-encrypted result is displayed to the voter; and
means configured to transfer the dual-encrypted result to the bulletin board system and, if the voter is an authorized voter, the bulletin board system allows the vote to be published.

61. The digital voting device according to claim 60, further comprising means configured to enable an initialization process to be carried out, wherein the validator system retrieves a list of the certificates of the authorized voters from the bulletin board system.

62. The digital voting device according to claim 60, further comprising:
means, in the mix network system, configured to retrieve the dual-encrypted votes from the bulletin board system after a voting phase;
means, in the mix network system, configured to remove an outer encryption from the dual-encrypted votes, using a private key of the mix network;
means, in the mix network system, configured to then mix the outer-decrypted votes and to send a new list to the bulletin board system, wherein the outer-decrypted votes are still encrypted by the tallier system's private key;
means, in the tallier system, configured to retrieve the new list from the bulletin board system and to further decrypt the outer-decrypted votes;
means, in the tallier system, configured to verify the signature of the validator system on the votes and to check whether the votes are valid; and
if the votes are valid, further configured to calculate the election result.

63. The digital voting device according to claim 62, further comprising means, in the tallier system, configured to publish all valid and invalid votes, including their signatures, at corresponding locations on the bulletin board system.

64. A mix network system for digital voting in communication with a bulletin board system, that the mix network system comprising:
a mix network server program configured to read unmixed dual-encrypted votes from the bulletin board system and to remove an outer encryption, using a private key of the mix network;
wherein the outer-decrypted votes are first collected in a local cache of the mix network, and after all the outer-decrypted votes are in the local cache, they are mixed and published on the bulletin board system in random order, and the local cache of the mix network is erased.
